(19) United States
(12) Patent Application Publication
(10) Pub. No.: US 2024/0357972 A1
(43) Pub. Date: Oct. 31, 2024

(54) POLE SAW WITH IMPROVED CLAMPING

(71) Applicant: Milwaukee Electric Tool Corporation, Brookfield, WI (US)

(72) Inventors: Jordan Smith, Sussex, WI (US); Tanazulibaad Israrahmed, Brookfield, WI (US); Scott Collins, Mequon, WI (US)

(21) Appl. No.: 18/645,446

(22) Filed: Apr. 25, 2024

Related U.S. Application Data
(60) Provisional application No. 63/621,277, filed on Jan. 16, 2024.
(60) Provisional application No. 63/461,736, filed on Apr. 25, 2023.

(51) Int. Cl. A01G 3/08; B25F 5/02

(52) U.S. Cl. CPC A01G 3/086; B25F 5/02

(57) ABSTRACT

A power tool includes a housing including an electric motor, a work element, a shaft extending between the housing and the work element, and a clamp coupled to the shaft and extending along a longitudinal axis between a first end and a second end. The shaft includes an outer shaft and an inner shaft. The clamp is actuatable between a locked position and an unlocked position. The inner shaft is configured to slide longitudinally within the outer shaft when the clamp is in the unlocked position. The outer shaft and the inner shaft are secured in a desired position when the clamp is in the locked position.

### CROSS-REFERENCE TO RELATED APPLICATIONS

This application is a non-provisional application claiming the benefit of priority under 35 U.S.C. § 119 (e) to U.S. Provisional Application No. 63/461,736, filed on Apr. 25, 2023, and U.S. Provisional Application No. 63/621,277, filed Jan. 16, 2024, which are hereby incorporated by reference in their entirety.

### FIELD

The present disclosure relates generally to outdoor power tools, such as pole saws and telescoping pole saws, with improved clamping.

### BACKGROUND

Telescoping pole tools, such as telescoping pole saws, allow a length of the pole tool to be adjusted to suit a particular need. For example, telescoping pole tools typically include an inner shaft that may slide longitudinally within an outer shaft, and a clamp for locking or securing the inner shaft and the outer shaft in place. The clamps for telescoping pole tools may present several issues. For example, the clamps may require many rotations to loosen and tighten the clamp. This may be time consuming and difficult for some operators. Additionally, the clamps may jam and become difficult to loosen.

Accordingly, improved clamps and telescoping pole tools having improved clamps are desired in the art. In particular, telescoping pole tools having clamps with improved clamping and adjustment capabilities would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a power tool is provided. The power tool includes a housing including an electric motor, a work element, a shaft extending between the housing and the work element, and a clamp coupled to the shaft and extending along a longitudinal axis between a first end and a second end. The shaft includes an outer shaft and an inner shaft. The clamp is actuatable between a locked position and an unlocked position. The inner shaft is configured to slide longitudinally within the outer shaft when the clamp is in the unlocked position. The outer shaft and the inner shaft are secured in a desired position when the clamp is in the locked position. The clamp includes an inner collar coupled to the outer shaft, an outer collar rotatable about the inner collar between the locked position and the unlocked position, and a collet within the outer collar adjacent the first end and configured to engage the inner collar in the locked position.

In accordance with another embodiment, a power tool is provided. The power tool includes a housing including an electric motor, a work element, a shaft extending between the housing and the work element, and a clamp coupled to the shaft and extending along a longitudinal axis between a first end and a second end. The shaft includes an outer shaft and an inner shaft. The clamp is actuatable between a locked position and an unlocked position. The inner shaft is configured to slide longitudinally within the outer shaft when the clamp is in the unlocked position. The outer shaft and the inner shaft are secured in a desired position when the clamp is in the locked position. The clamp includes an inner collar coupled to the outer shaft, an outer collar rotatable about the inner collar between the locked position and the unlocked position, a biasing member between the inner collar and the outer collar, and a release button coupled to the inner collar. The outer collar includes a plurality of protrusions extending from an interior surface of the outer collar adjacent the second end. The release button defines one or more slots for receiving one or more of the plurality of protrusions of the outer collar.

In accordance with another embodiment, a method of using a power tool is provided. The method includes providing a pole tool. The pole tool includes a housing including an electric motor, a work element, a shaft extending between the housing and the work element, and a clamp extending along a longitudinal axis between a first end and a second end. The shaft includes an outer shaft and an inner shaft, and the inner shaft is configured to slide longitudinally within the outer shaft. The clamp is configured to secure the outer shaft and the inner shaft in a desired position. The clamp includes an inner collar and an outer collar configured to engage the inner collar. The method further includes rotating the outer collar of the clamp in a first direction about the inner collar such that the outer collar moves towards the first end to an unlocked position, translating the inner shaft within the outer shaft to the desired position, and rotating the outer collar of the clamp in a second direction about the inner collar such that the outer collar moves towards the second end to a locked position.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1A is a perspective view of a pole saw in an extended position in accordance with embodiments of the present disclosure;

FIG. 1B is a perspective view of the pole saw of FIG. 1A in a retracted position in accordance with embodiments of the present disclosure;

FIG. 2A is a perspective view of a clamp of the pole saw of FIGS. 1A-1B in accordance with embodiments of the present disclosure;

FIG. 2B is a detailed, perspective view of an end of the clamp of FIG. 2A in accordance with embodiments of the present disclosure;

FIG. 2C is an exploded view of the clamp of FIG. 2A in accordance with embodiments of the present disclosure;

FIG. 2D is a cross-section view of the clamp of FIG. 2A in accordance with embodiments of the present disclosure;

FIG. 2E is a detailed, interior view of the clamp of FIG. 2A in accordance with embodiments of the present disclosure;

FIG. 3A is a perspective of the clamp of FIGS. 1A-1B in a locked position in accordance with embodiments of the present disclosure;

FIG. 3B is a perspective view of the clamp of FIG. 3A in an unlocked position in accordance with embodiments of the present disclosure;

FIG. 4A is a detailed, perspective view of a clamp in accordance with embodiments of the present disclosure;

FIG. 4B is a perspective view of an outer collar of the clamp of FIG. 4A in accordance with embodiments of the present disclosure;

FIG. 4C is an interior, perspective view of the outer collar of FIG. 4B in accordance with embodiments of the present disclosure;

FIG. 4D is a perspective view of an inner collar of the clamp of FIG. 4A in accordance with embodiments of the present disclosure; and

FIG. 5 is a flow chart of a method of operating the pole saw of FIGS. 1A-1B in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive—or and not to an exclusive—or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, telescoping pole saws include an outer shaft and an inner shaft that is configured to slide within the outer shaft such that a length of the telescoping pole saw is customizable. The telescoping pole saw includes a clamp for securing the inner shaft and the outer shaft in a locked position during operation. The clamp may provide sufficient force to maintain the inner shaft and the outer shaft in the locked position while requiring minimal rotation of the clamp to loosen and tighten the clamp.

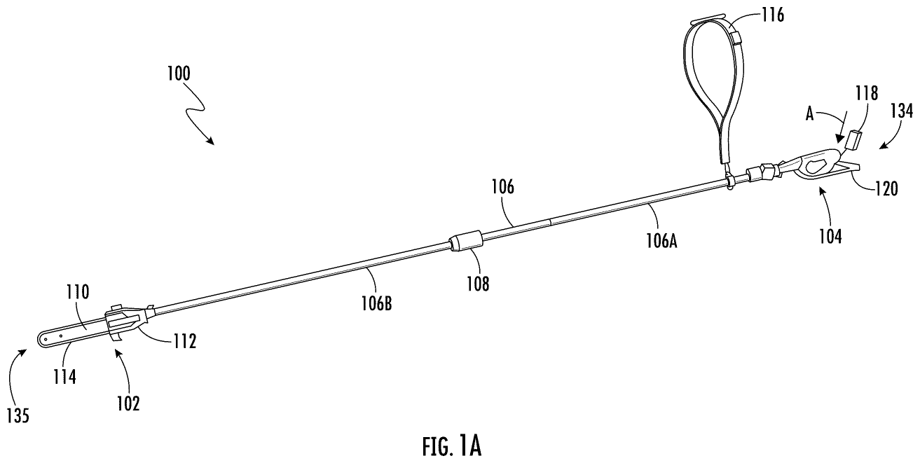

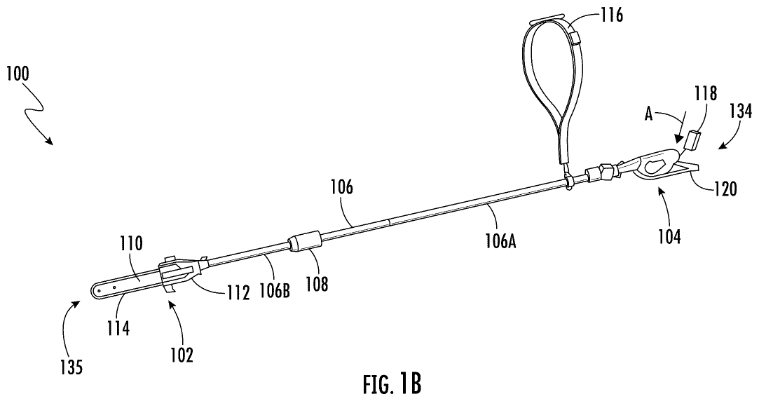

Referring now to the drawings, FIG. 1A illustrates a perspective view of a pole saw in an extended position in accordance with embodiments of the present disclosure. FIG. 1B illustrates a perspective view of the pole saw of FIG. 1A in a retracted position in accordance with embodiments of the present disclosure.

In at least one example embodiment, a pole tool 100 generally includes a work element 102, a housing 104, and a shaft, such as a pole 106, extending between and connecting together the work element 102 and the housing 104. The housing 104 may be at a first end, such as a rear end 134, of the pole tool 100 and the work element 102 may be at a second end, such as a front end 135, opposite the first end of the pole tool 100.

In at least one example embodiment, the pole 106 is adjustable in length. For example, the pole 106 may be telescopic, including one or more segments that telescopically move relative to one another. The pole tool 100 may include an outer shaft 106A and an inner shaft 106B. The inner shaft 106B may be configured to slide longitudinally within the outer shaft 106A between an extended position (shown in FIG. 1A) and a retracted position (shown in FIG. 1B). An operator may adjust a distance between the work element 102 and the housing 104 by adjusting the relative positions of the outer shaft 106A and the inner shaft 106B with respect to one another. For example, the operator may move the outer shaft 106A and the inner shaft 106B between the retracted position and the extended position. In at least one example embodiment, a clamp 108 may be used to maintain the outer shaft 106A and the inner shaft 106B at relatively fixed positions with respect to one another.

In at least one example embodiment, the work element 102 of the pole tool 100 is a sawing tool configured to cut material. The sawing tool includes a bar 110 extending from a work element housing 112. A chain 114 extends in an infinite loop around the bar 110 and is driven to move along a track of the bar 110. While holding the pole tool 100 at the housing 104 and the pole 106, an operator can maneuver the sawing tool into position near an object, such as a branch, and urge the chain 114 into the object with the chain 114 in motion to cut the object. The operator can repeat this process as necessary. An optional shoulder or body strap 116 may be coupled to at least a portion of the pole tool 100. For example, the optional shoulder or body strap 116 may be coupled to a portion of the pole 106 adjacent the housing 104. The optional shoulder or body strap 116 may be used for prolonged use of the pole tool 100 to mitigate fatigue.

In at least one example embodiment, the chain 114 is driven by a motor (not shown). For example, the motor may be housed within the housing 104. A driveshaft can extend through the pole 106 to transfer power from the motor to the chain 114 through a chain sprocket. In other example embodiments, the motor may be housed within the work element housing 112 and drive the chain 114 through a chain sprocket.

In at least one example embodiment, the motor may be an electric motor, such as a direct current (DC) brushless motor. The motor includes an output shaft rotatably pinned to the chain sprocket, e.g., through a driveshaft. As the output shaft rotates, the chain 114 is driven within the track of the bar 110. In an example embodiment, the motor receives electrical power from a power source 118. For example, the power source 118 may include one or more batteries.

In at least one example embodiment, the pole tool 100 includes a receiving area 120 configured to receive the power source 118. For example, the receiving area 120 may be configured to receive one or more batteries, such as at least two batteries, at least three batteries, or even at least four batteries. In at least one example embodiment, the power source 118 may be installed in the receiving area 120 through a translational motion oriented in a direction shown by arrow A. In other example embodiments, the power source 118 may be installed in the receiving area 120 through a translational motion oriented in another direction, in a rotational motion, or in a translational-rotational motion.

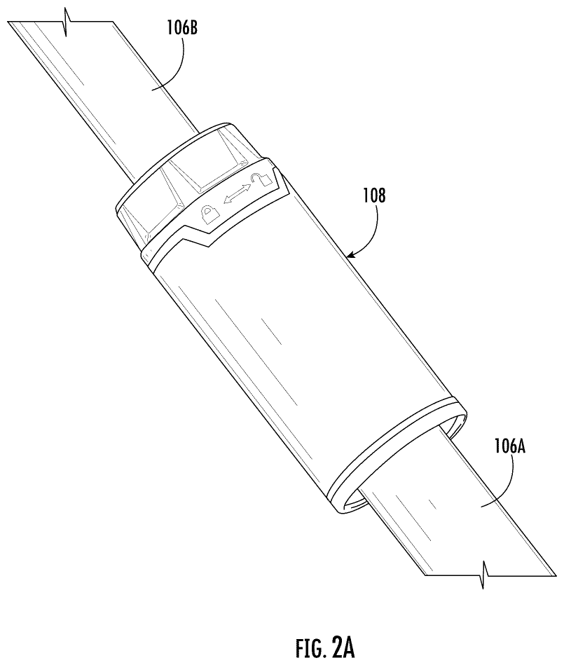

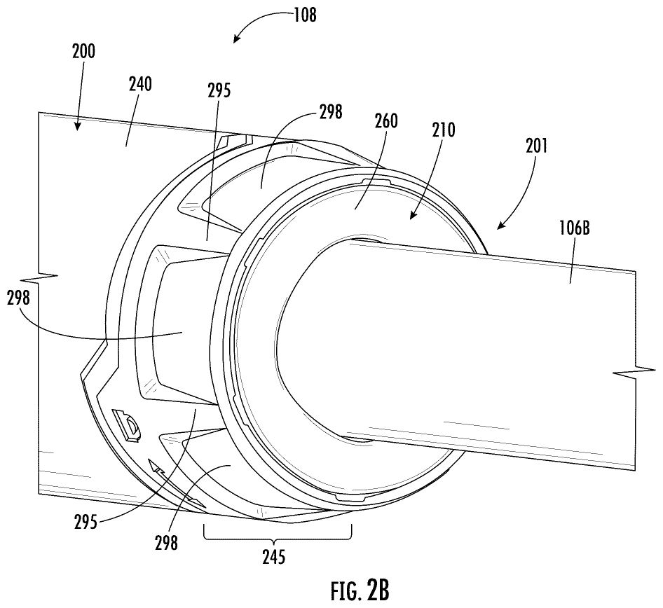

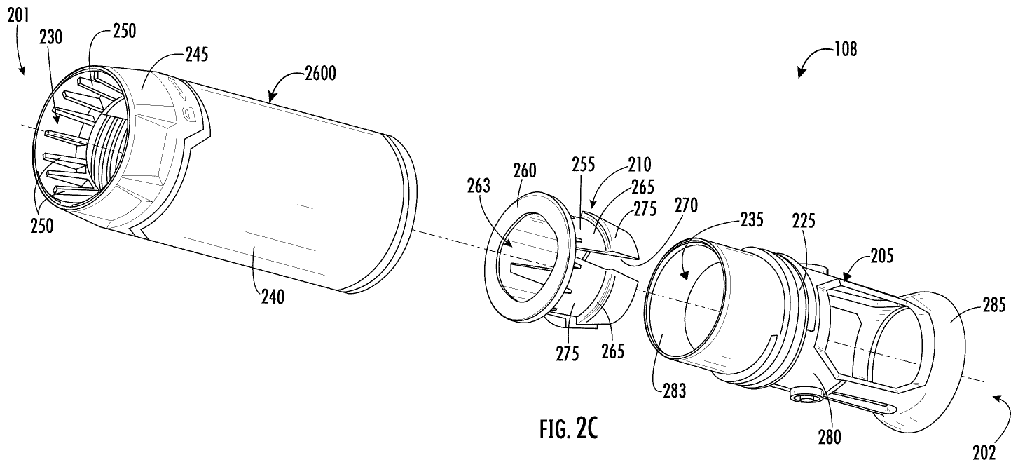

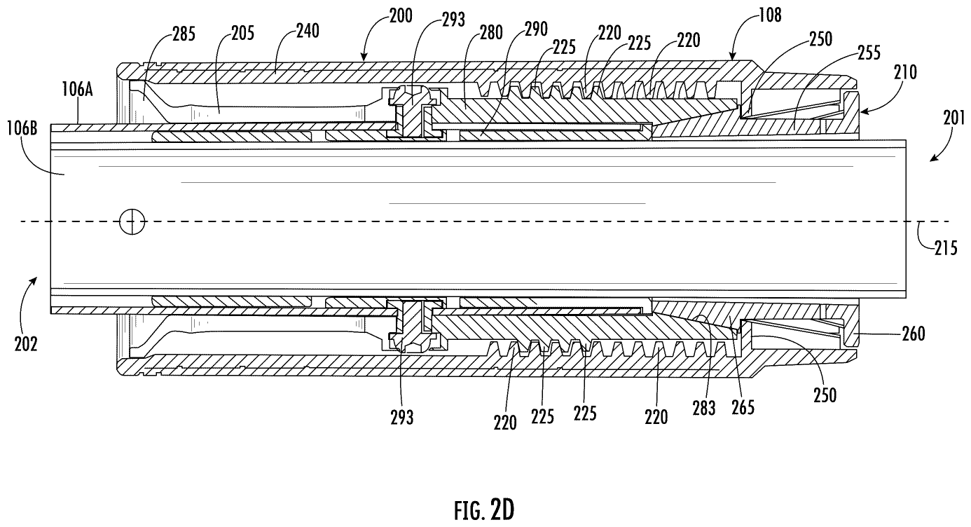

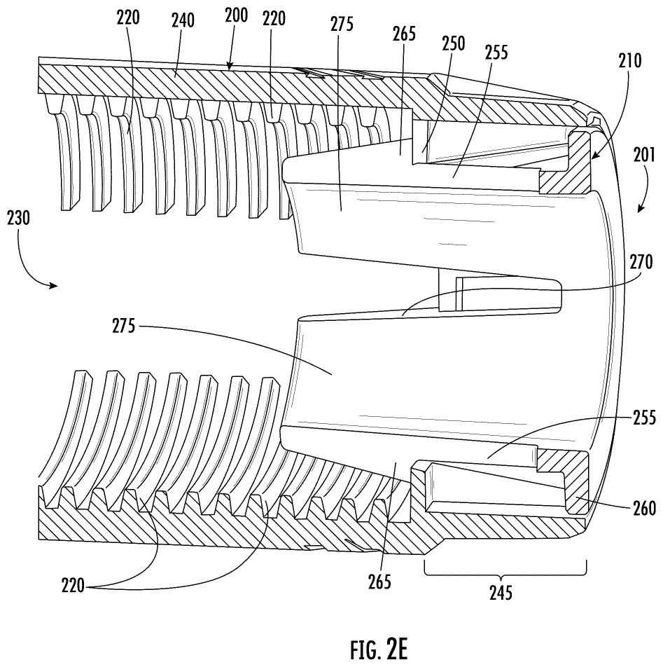

FIG. 2A illustrates a perspective view of a clamp of the pole saw of FIGS. 1A-1B in accordance with embodiments of the present disclosure. FIG. 2B illustrates a detailed, perspective view of an end of the clamp of FIG. 2A in accordance with embodiments of the present disclosure. FIG. 2C illustrates an exploded view of the clamp of FIG. 2A in accordance with embodiments of the present disclosure. FIG. 2D illustrates a cross-section view of the clamp of FIG. 2A in accordance with embodiments of the present disclosure. FIG. 2E illustrates a detailed, interior view of the clamp of FIG. 2A in accordance with embodiments of the present disclosure.

In at least one example embodiment, the clamp 108 includes an outer collar 200, an inner collar 205, and a collet 210. The outer collar 200 extends along a longitudinal axis 215 from a first end 201 to a second end 202 of the clamp 108. Additionally, the inner collar 205 and the collet 210 extend along the longitudinal axis 215 such that central axes extending through each of the outer collar 200, the inner collar 205, and the collet 210 are aligned with the longitudinal axis 215.

In at least one example embodiment, the outer collar 200 is configured to receive at least a portion of the inner collar 205 and the collet 210. For example, the outer collar 200 defines a first opening 230 configured to receive at least a portion of the inner collar 205 and the collet 210. Additionally, the outer collar 200 includes a first plurality of threads 220 extending from an interior surface into the first opening 230 of the outer collar 200 adjacent the first end 201.

In at least one example embodiment, the outer collar 200 includes a base portion 240 adjacent the second end 202 and an end portion 245 adjacent the first end 201. For example, the end portion 245 may extend from the base portion 240 towards the first end 201. In at least one example embodiment, the base portion 240 and the end portion have a substantially cylindrical shape. Additionally, a diameter of the end portion 245 may decrease from the base portion 240 towards the first end 201. In other example embodiments, the diameter of the end portion 245 and the base portion 240 are substantially equal.

In at least one example embodiment, the outer collar 200 includes at least one protrusion 250 extending from an interior surface of the outer collar 200 adjacent the first end 201. For example, the at least one protrusion 250 may extend from an interior surface of the end portion 245. The at least one protrusion 250 may include an inclined surface such that a diameter of the first opening 230 within the end portion 245 decreases from the first end 201 towards the second end 202. In at least one example embodiment, the at least one protrusion 250 includes a plurality of protrusions extending from the interior surface of the end portion 245 of the outer collar 200, as shown in FIG. 2C. In other example embodiments, the at least one protrusion 250 may be a single, continuous protrusion extending about an inner circumference of the end portion 245 of the outer collar 200.

In at least one example embodiment, the collet 210 includes a collet base 255 and a flange 260 extending from the collet base 255 adjacent the first end 201. An end of the collet 210 adjacent the second end 202 may also define an inclined surface having a width increasing from the second end 202 towards the first end 201. For example, the collet 210 includes at least one collet protrusion 265 extending from an exterior surface of the collet base 255 opposite the flange 260. The collet 210 may have a substantially cylindrical shape. The collet 210 defines a second opening 263 configured to receive at least a portion of the inner shaft 106B. Additionally, the collet base 255 of the collet 210 may be discontinuous. For example, the collet base 255 may define a plurality of recesses or gaps 270 with a plurality of deformable members 275 between each of the plurality of gaps 270. Each of the plurality of deformable members 275 may include the at least one collet protrusion 265. In other example embodiments, the collet base 255 is a continuous.

In at least one example embodiment, the inner collar 205 includes a base portion 280 extending along the longitudinal axis 215 and a flange 285 extending from the base portion 280 adjacent the second end 202. The base portion 280 and the flange 285 may have a substantially cylindrical shape and define a third opening 235 through the inner collar 205. The third opening 235 is configured to receive at least a portion of the outer shaft 106A. The third opening 235 may also receive at least a portion of the inner shaft 106B. Additionally, an end of the inner collar 205 adjacent the first end 201 defines an inclined surface having a width increasing from the first end 201 towards the second end 202. For example, an interior surface of the inner collar 205 includes a tapered surface 283 adjacent the first end 201. Moreover, the tapered surface 283 tapers or narrows towards the first end 201 such that a diameter of the third opening 223 increases towards the first end 201.

In at least one example embodiment, the inner collar 205 includes a second plurality of threads 225 extending from an exterior surface of the inner collar 205 adjacent the first end 201. For example, the second plurality of threads 225 may extend from an exterior surface of the base portion 280. The second plurality of threads 225 of the inner collar 205 are configured to engage the first plurality of threads 220 of the outer collar 200.

In at least one example embodiment, the first end 201 of the outer collar 200 is configured to receive the collet 210. For example, the collet 210 is inserted into the first opening 230 at the end portion 245 of the outer collar 200. The at least one collet protrusion 265 is configured to engage the at least one protrusion 250 of the outer collar. For example, as the collet 210 is inserted into the end portion 245 of the outer collar 200, the at least one collet protrusion 265 slides past the at least one protrusion 250. The plurality of deformable members 275 of the collet 210 may be pushed inwards by the at least one protrusion 250 until the at least one collet protrusion 265 is seated on or engaged with the at least one protrusion 250, as shown in FIG. 2E. Once the collet 210 is seated within the outer collar 200, as shown in FIGS. 2D-2E, the collet 210 will not move axially along the longitudinal axis 215 relative to the outer collar 200. In at least one example embodiment, the flange 260 of the collet 210 is flush with an end of the outer collar 200, such as an end of the end portion 245, when the collet 210 is fully seated within the outer collar 200.

In at least one example embodiment, the outer collar 200 is rotatable about the inner collar 205 between an unlocked position and a locked position (shown in FIG. 2D). In the unlocked position, the inner shaft 106B may slide axially within the outer shaft 106A along the longitudinal axis 215. For example, an operator of the pole tool 100 may slide the inner shaft 106B to a desired position within outer shaft 106A such that the pole tool 100 is a desired length for operation.

In at least one example embodiment, rotation of the outer collar 200 about the inner collar 205 in a first direction moves the outer collar 200 towards the second end 202 to the unlocked position. Rotation of the outer collar 200 about the inner collar 205 in a second direction moves the outer collar 200 towards the first end 201 to the locked position (shown in FIG. 2D). The second direction is opposite the first direction. For example, the first direction may be a counterclockwise direction about the longitudinal axis 215 and the second direction may be a clockwise direction about the longitudinal axis 215. In other example embodiments, the first direction may be a clockwise direction about the longitudinal axis 215 and the second direction may be a counterclockwise direction about the longitudinal axis 215.

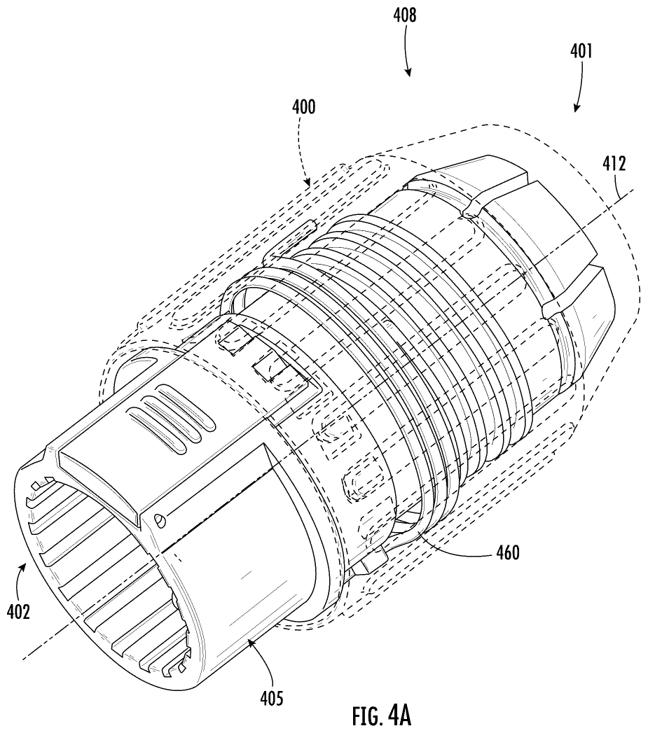

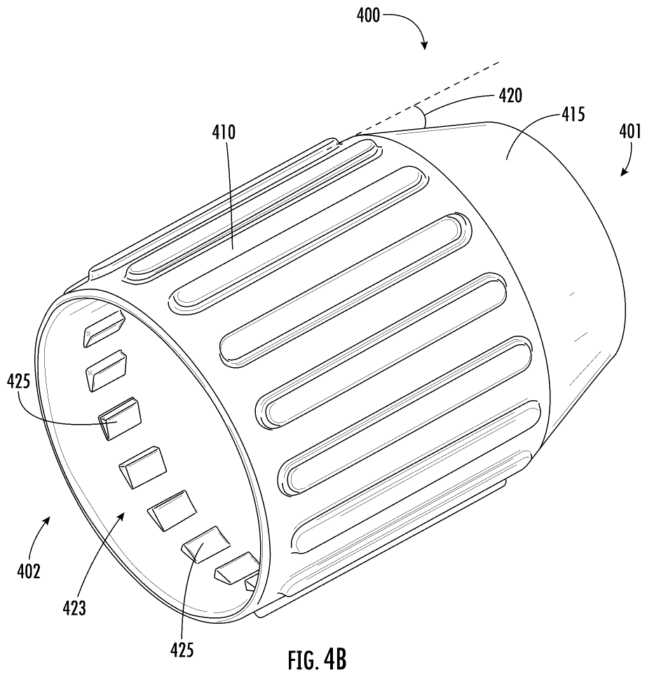

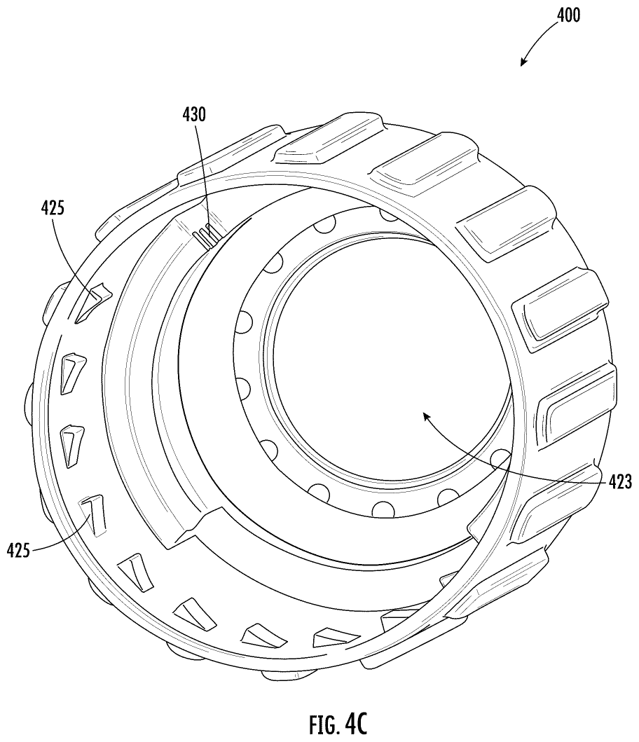

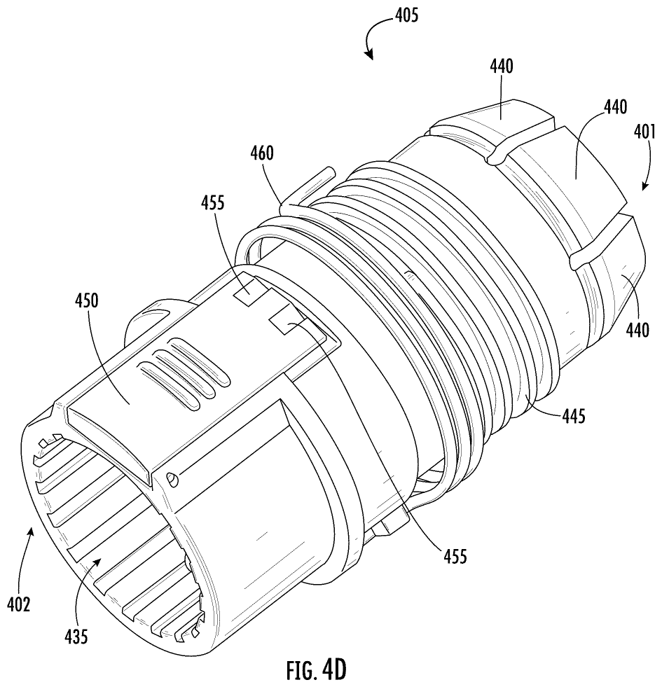

In at least one example embodiment, rotation of the outer collar 200 about the inner collar 205 in the first direction moves both the outer collar 200 and the collet 210 towards the second end 202 to the unlocked position, and rotation of the outer collar 200 about the inner collar 205 in the second direction moves both the outer collar 200 and the collet 210 towards the first end 201 to the locked position. The outer collar 200 rotates about the inner collar 205 via the threaded engagement between the first plurality of threads 220 and the second plurality of threads 225. In at least one example embodiment, the outer collar 200 is configured to rotate less than or equal to about 90° in the first direction and less than or equal to about 90° in the second direction. In other example embodiments, the outer collar 200 may rotate freely about the inner collar 205 greater than 90°, as will be discussed with respect to FIG. 4, below.

In at least one example embodiment, the collet 210 is rotational isolated from rotation of the outer collar 200. For example, as the outer collar 200 rotates, the collet 210 does not rotate. However, movement of the outer collar 200 towards the first end 201 and the second end 202 also moves the collet 210 along the longitudinal axis 215 towards the first end 201 and the second end 202.

In at least one example embodiment, movement of the outer collar 200 and the collet 210 towards the second end 202 moves the collet 210 into engagement with at least a portion of the inner collar 205. For example, the at least one collet protrusion 265 is configured to engage the tapered surface 283 of the inner collar 205. In the locked position, shown in FIG. 2D, the at least one collet protrusion 265 is seated within the tapered surface 283 of the inner collar such that the tapered surface 283 at the first end 201 of the inner collar 205 circumscribes the at least one collet protrusion 265 of the collet 210. As the tapered surface 283 engages the at least one collet protrusion 265, the tapered surface 283 of the inner collar 205 exerts an inward force towards the longitudinal axis 215 on the plurality of deformable members 275. The inward force exerted by the tapered surface 283 on the at least one collet protrusion 265 also pushes the plurality of deformable members 275 inward towards the longitudinal axis 215 to engage the inner shaft 106B. Engagement of the inner shaft 106B places the clamp 108 in the locked position such that the inner shaft 106B and the outer shaft 106A are in the desired position and the inner shaft 106B is prevented from sliding within the outer shaft 106A.

In at least one example embodiment, movement of the outer collar 200 and the collet 210 towards the first end 201 moves the collet 210 out of engagement with the inner collar 205. For example, the tapered surface 283 is no longer engaged with the at least one collet protrusion 265 such that the plurality of deformable members 275 are released from engagement with the inner shaft 106B. In such embodiments, the clamp 108 is now in the unlocked position such that the inner shaft 106B may slide within the outer shaft 106A.

With reference to FIG. 2D, the clamp 108 may include a mount 290 in some example embodiments. The mount 290 may include a cylindrical plate configured to be coupled to an inner surface of the outer shaft 106A. The outer shaft 106A and the inner collar 205 may define one or more corresponding openings for receiving one or more fasteners 293. The one or more fasteners 293 are configured to secure the inner collar 205 to the outer shaft 106A via the mount 290. In at least one example embodiment, the one or more fasteners 293 may include one or more bolts, one or more screws, one or more pins, or a combination thereof.

Referring now to FIG. 2B, the first end 201 of the outer collar 200 includes a plurality of protrusions, such as a plurality of projections 295, and defines a plurality of depressions 298 between each of the plurality of projections 295. For example, the end portion 245 includes the plurality of projections 295 and the plurality of depressions 298. In at least one example embodiment, the plurality of projections 295 may be evenly spaced about the exterior surface of the end portion 245 of the outer collar 200. In other example embodiments, the plurality of projections 295 are unevenly spaced about the exterior surface of the end portion 245 of the outer collar 200.

In at least one example embodiment, the plurality of projections 295 provide an engagement surface for a tool. For example, a tool, such as a wrench, may be able to grip the outer collar 200 via the plurality of projections 295 in order to rotate the outer collar in the first direction and the second direction. A tool may be needed to rotate the outer collar 200 in the event the clamp 108 jams and an operator of the pole tool 100 is unable to rotate the outer collar 200 of the clamp 108.

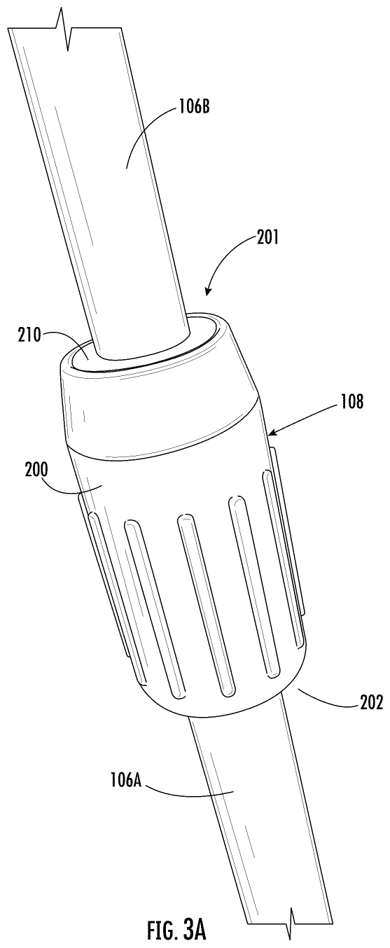

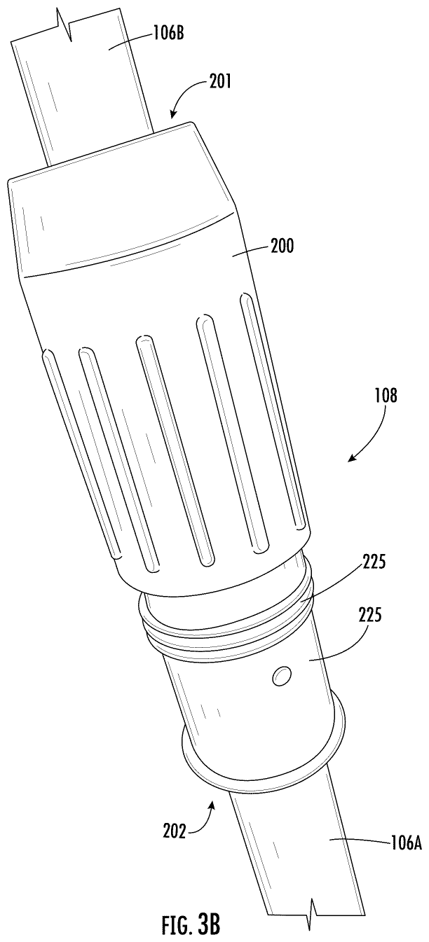

FIG. 3A illustrates a perspective of the clamp of FIGS. 1A-1B in a locked position in accordance with embodiments of the present disclosure. FIG. 3B illustrates a perspective view of the clamp of FIG. 3A in an unlocked position in accordance with embodiments of the present disclosure.

In at least one example embodiment, rotation of the outer collar 200 from the locked position (shown in FIG. 3A) to the unlocked position allows the outer collar 200 to slide away from the inner collar 205, as shown in FIG. 3B. For example, in the outer collar 200 may be rotated to the unlocked position until the first plurality of threads 220 disengage from the second plurality of threads 225. After the first plurality of threads 220 are disengaged from the second plurality of threads 225, the outer collar 200 may slide away from the inner collar 205 in the direction of the first end 201, as shown in FIG. 3B. Additionally, the inner shaft 106B may slide within the outer shaft 106A.

FIG. 4A illustrates a detailed, perspective view of a clamp in accordance with embodiments of the present disclosure. FIG. 4B illustrates a perspective view of an outer collar of the clamp of FIG. 4A in accordance with embodiments of the present disclosure. FIG. 4C illustrates an interior, perspective view of the outer collar of FIG. 4B in accordance with embodiments of the present disclosure. FIG. 4D illustrates a perspective view of an inner collar of the clamp of FIG. 4A in accordance with embodiments of the present disclosure.

In at least one example embodiment, the pole tool 100 includes a clamp 408. For example, the clamp 408 may be used in place of the claim 108 shown in FIGS. 1A-1B. The clamp 408 includes an outer collar 400 and an inner collar 405. The clamp 408 extends along a longitudinal axis 412 between a first end 401 and a second end 402. The longitudinal axis 412 aligns with a central axis extending along a length of the shaft 106. Additionally, central axes extending through both the outer collar 400 and the inner collar 405 align with the longitudinal axis 412.

With reference to FIGS. 4B-4C, the outer collar 400 includes a base portion 410 adjacent the second end 402 and an end portion 415 adjacent the first end 401. For example, the end portion 415 may be an inclined portion extending from the base portion 410 towards the first end 401. For example, the end portion 415 tapers from the base portion 410 towards the first end 401. The end portion 415 may form an angle 420 with an outer surface of the base portion 410. In some example embodiments, the angle 420 is less than about 90°. For example, the angle 420 may be about 45°.

In at least one example embodiment, the outer collar 400 defines a first opening 423. The first opening 423 is configured to receive at least a portion of the inner collar 405. Additionally, the outer collar 400 includes a plurality of protrusions 425 extending from an interior surface of the outer collar 400 adjacent the second end 402 into the first opening 423. In at least one example embodiment, each of the plurality of protrusions 425 may be tapered from one end to an opposite end. For example, each of the plurality of protrusions 425 may taper from an end adjacent a neighboring one of the plurality of protrusions to an opposite end neighboring another one of the plurality of protrusions 425. The plurality of protrusions 425 may also be evenly spaced about a circumference of the inner surface of the outer collar 400. In other example embodiments, the plurality of protrusions 425 may be unevenly spaced about the circumference of the inner surface of the outer collar 400.

In at least one example embodiment, the outer collar 400 includes a first plurality of threads 430 extending from an interior surface of the outer collar 400. The first plurality of threads 430 may be opposite the plurality of protrusions 425 and adjacent the first end 401. For example, the first plurality of threads 430 may extend from an interior surface of the base portion 410 of the outer collar 400 adjacent the first end 401. In at least one example embodiment, the first plurality of threads 430 are discontinuous about the interior surface of the outer collar 400. In other example embodiments, the first plurality of threads 430 are continuous about the interior surface of the outer collar 400.

Referring now to FIG. 4D, the inner collar 405 defines a second opening 435 configured to receive at least a portion of the outer shaft 106A and the inner shaft 106B. For example, at least a portion of the inner collar 405 may be fixedly coupled to a portion of the outer shaft 106A and another portion of the inner collar 405 may be configured to engage a portion of the inner shaft 106B. In at least one example embodiment the inner collar 405 includes a plurality of deformable members 440 extending from the first end 401 of the inner collar 405. The plurality of deformable members 440 are configured to engage the inner shaft 106B, as will be discussed in greater detail below.

In at least one example embodiment, the inner collar 405 includes a second plurality of threads 445 extending from an exterior surface of the inner collar 405. The second plurality of threads 445 may be adjacent the first end 401. The second plurality of threads 445 are configured to engage the first plurality of threads 430 of the outer collar 400. Additionally, the inner collar includes an actuator, such as a release button 450, adjacent the second end 402. The release button 450 defines one or more slots 455 configured to receive the plurality of protrusions 425 of the outer collar 400.

In at least one example embodiment, the clamp 408 includes a biasing member 460. The biasing member 460 may be positioned between the inner collar 405 and the outer collar 400. For example, the biasing member 460 may be a spring wrapped around at least a portion of the inner collar 405. In at least one example embodiment, the biasing member is a torsional spring.

In at least one example embodiment, the outer collar 400 is rotatable about the inner collar 405 between an unlocked position and a locked position. For example, the outer collar 400 rotates about the inner collar 405 via engagement of the first plurality of threads 430 of the outer collar 400 with the second plurality of threads 445 of the inner collar 405. Rotation of the outer collar 400 about the inner collar 405 in a first direction moves the outer collar 400 in an axial direction towards the second end 402 to the locked position. In the locked position, at least one of the plurality of protrusions 425 are configured to engage the one or more slots 455, as shown in FIG. 4A. Rotation of the outer collar 400 about the inner collar 405 in the first direction to the locked position also engages the biasing member 460. For example, in the locked position, the biasing member is in an engaged or a retracted position.

Additionally, as the outer collar 400 is moving towards the second end 402 to the locked position, the end portion 415 begins exerting an inward force on the plurality of deformable members 440. For example, the inward force exerted by the end portion 415 pushes the plurality of deformable members 440 inward toward the longitudinal axis 412 and the inner shaft 106B. Moreover, in the locked position, the plurality of deformable members 440 exert a force or pressure on the inner shaft 106B. Engagement of the plurality of deformable member 440 with the inner shaft 106B places the clamp 408 in the locked position such that the inner shaft 106B and the outer shaft 106A are secured in the desired position and the inner shaft 106B is prevented from sliding within the outer shaft 106A.

In at least one example embodiment, applying a force to the release button 450 or depressing the release button 450 is configured to release one or more of the plurality of protrusions 425 from the one or more slots 455 such that the outer collar 400 may rotate in a second direction. Releasing the plurality of protrusions 425 from the one or more slots 455 also allows the energy stored in the retracted biasing member 460 to be released. Accordingly, the energy released by the biasing member 460 as it returns to its disengaged or extended position causes the outer collar 400 to rotate in the second direction. The second direction is opposite the first direction. In at least one example embodiment, the first direction is a counterclockwise direction, and the second direction is a clockwise direction. In other example embodiments, the first direction is the clockwise direction, and the second direction is the counterclockwise direction.

In at least one example embodiment, rotation of the outer collar 400 in the second direction moves the outer collar in an axial direction towards the first end 401 to the unlocked position. In the unlocked position, the end portion 415 is disengaged from the plurality of deformable members 440 such that the plurality of deformable members 440 are disengaged from the inner shaft 106B. Accordingly, the inner shaft 106B may slide within the outer shaft 106A in the unlocked position.

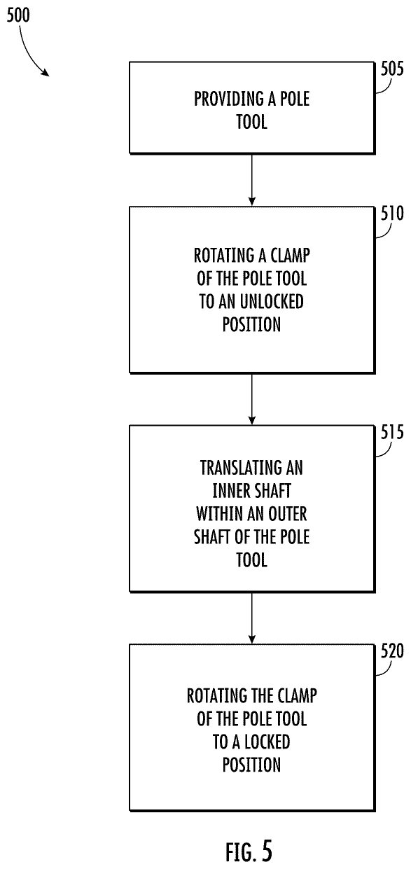

FIG. 5 illustrates a flow chart of a method of operating the pole saw of FIGS. 1A-1B in accordance with embodiments of the present disclosure.

In at least one example embodiment, a method 500 of operating a power tool, such as the pole tool 100, includes providing a pole tool at 505, rotating a clamp of the pole tool to an unlocked position at 510, translating an inner shaft of the pole tool within an outer shaft of the pole tool at 515, and rotating the clamp of the pole tool to a locked position at 520.

In at least one example embodiment, providing a pole tool at 505 includes providing the pole tool 100, as shown in FIGS. 1A-1B. The pole tool 100 includes the housing 104 including the electric motor, the work element 102, and the pole 106 extending between the housing 104 and the work element 102. The electric motor may also be disposed in the housing 104. The pole 106 includes the outer shaft 106A and the inner shaft 106B, and the inner shaft 106B is configured to slide longitudinally within the outer shaft 106A.

In at least one example embodiment, the pole tool 100 includes the clamp 108, as shown in FIGS. 2A-3B. The clamp 108 extends along the longitudinal axis 215 between the first end 201 and the second end 202. The clamp 108 is configured to secure the outer shaft 106A and the inner shaft 106B in the desired position. Additionally, the clamp 108 includes the outer collar 200 and the inner collar 205.

In additional example embodiments, the pole tool 100 includes the clamp 408, as shown in FIGS. 4A-4D. The clamp 408 extends along the longitudinal axis 412 between the first end 401 and the second end 402. The clamp 408 is configured to secure the outer shaft 106A and the inner shaft 106B in the desired position. Additionally, the clamp 108 includes the outer collar 400 and the inner collar 404.

In at least one example embodiment, rotating the clamp of the pole to an unlocked position at 510 includes rotating the outer collar 200 of the clamp 108 in the first direction about the inner collar 205 such that the outer collar 200 moves towards the first end 201 to the unlocked position. Rotating the outer collar 200 in the first direction may include rotating the outer collar 200 about the inner collar 205 less than or equal to about 90°. In another example embodiment, rotating the clamp of the pole to an unlocked position at 510 includes rotating the outer collar 400 of the clamp 408 the first direction about the inner collar 405 such that the outer collar 400 moves towards the first end 401 to the unlocked position. In such embodiments, the clamp 408 may include the biasing member 460 and the inner collar 405 may include the release button 450. Accordingly, rotating the outer collar 400 of the clamp 408 in the first direction may also include applying a force to the release button 450 such the plurality of protrusions 425 disengage from the one or more slots 455 and the biasing member 460 rotates the outer collar 400 in the first direction to the unlocked position, as discussed above with respect to FIGS. 4A-4D.

In at least one example embodiment, translating the inner shaft within the outer shaft of the pole tool at 515 includes translating the inner shaft 106B within the outer shaft 106A to the desired position. For example, the operator of the pole tool 100 may adjust a length of the pole tool by sliding the inner shaft 106B within the outer shaft 106A to the desired position.

In at least one example embodiment, rotating the clamp of the pole tool to the locked position at 520 includes rotating the outer collar 200 of the clamp 108 in the second direction about the inner collar 205 such that the outer collar 200 moves towards the second end 202 to the locked position. Rotating the outer collar 300 in the second direction may include rotating the outer collar 200 about the inner collar 205 less than or equal to about 90°. In another example embodiment, rotating the clamp of the pole tool to the locked position at 520 includes rotating the outer collar 400 of the clamp 408 in the second direction about the inner collar 405 such that the outer collar 400 moves towards the second end 402 to the locked position. For example, the outer collar 400 may be rotated in the second direction until one or more of the plurality of protrusions 425 engage the one or more slots 455, as discussed above with respect to FIGS. 4A-4D. In the locked position, the outer shaft 106A and the inner shaft 106B are secured in the desired position such that the inner shaft 106B is prevented from sliding within the outer shaft. Accordingly, the operator may then operate the pole tool 100 as desired.

Further aspects of the invention are provided by one or more of the following embodiments:

A power tool includes a housing including an electric motor, a work element, a shaft extending between the housing and the work element, and a clamp coupled to the shaft and extending along a longitudinal axis between a first end and a second end. The shaft includes an outer shaft and an inner shaft. The clamp is actuatable between a locked position and an unlocked position. The inner shaft is configured to slide longitudinally within the outer shaft when the clamp is in the unlocked position. The outer shaft and the inner shaft are secured in a desired position when the clamp is in the locked position. The clamp includes an inner collar coupled to the outer shaft, an outer collar rotatable about the inner collar between the locked position and the unlocked position, and a collet within the outer collar adjacent the first end and configured to engage the inner collar in the locked position.

The power tool of any one or more of the embodiments, wherein an interior surface of the outer collar includes a first plurality of threads adjacent the first end, an exterior surface of the inner collar includes a second plurality of threads adjacent the first end, and the first plurality of threads are configured to engage the second plurality of threads.

The power tool of any one or more of the embodiments, wherein rotation of the outer collar in a first direction moves the outer collar and the collet towards the second end to the locked position, rotation of the outer collar in a second direction moves the outer collar and the collet towards the first end to the unlocked position, and the second direction is opposite the first direction.

The power tool of any one or more of the embodiments, wherein the collet is configured to engage the inner shaft in the locked position and prevent movement of the inner shaft.

The power tool of any one or more of the embodiments, wherein the collet is rotationally isolated from the outer collar.

The power tool of any one or more of the embodiments, wherein the outer collar is configured to rotate about the inner collar less than or equal to 90° in the first direction and less than or equal to 90° in the second direction.

The power tool of any one or more of the embodiments, wherein an end of the collet adjacent the second end defines a first inclined surface having a width increasing from the second end towards the first end, an end of the inner collar adjacent the first end defines a second inclined surface having a width increasing from the first end towards the second end, and the first inclined surface engages the second inclined surface in the locked position.

The power tool of any one or more of the embodiments, further including a mount configured to secure the inner collar to the outer shaft and one or more fasteners configured to secure the mount to the inner collar and the outer shaft.

The power tool of any one or more of the embodiments, wherein the mount includes a cylindrical plate coupled to an interior surface of the outer shaft.

The power tool of any one or more of the embodiments, wherein the outer collar includes a plurality of protrusions extending from an outer surface adjacent the first end. The plurality of protrusions are spaced about a circumference of the outer collar.

A power tool includes a housing including an electric motor, a work element, a shaft extending between the housing and the work element, and a clamp coupled to the shaft and extending along a longitudinal axis between a first end and a second end. The shaft includes an outer shaft and an inner shaft. The clamp is actuatable between a locked position and an unlocked position. The inner shaft is configured to slide longitudinally within the outer shaft when the clamp is in the unlocked position. The outer shaft and the inner shaft are secured in a desired position when the clamp is in the locked position. The clamp includes an inner collar coupled to the outer shaft, an outer collar rotatable about the inner collar between the locked position and the unlocked position, a biasing member between the inner collar and the outer collar, and a release button coupled to the inner collar. The outer collar includes a plurality of protrusions extending from an interior surface of the outer collar adjacent the second end. The release button defines one or more slots for receiving one or more of the plurality of protrusions of the outer collar.

The power tool of any one or more of the embodiments, wherein the inner collar includes a first plurality of threads extending from an outer surface of the inner collar adjacent the first end and the outer collar includes a second plurality of threads extending from an inner surface of the outer collar. The second plurality of threads are configured to engage the first plurality of threads.

The power tool of any one or more of the embodiments, wherein rotation of the outer collar about the inner collar in a first direction moves the outer collar towards the second end to the locked position, rotation of the outer collar about the inner collar in a second direction moves the outer collar towards the first end to the unlocked position, and the second direction is opposite the first direction.

The power tool of any one or more of the embodiments, wherein the inner collar includes a plurality of deformable members adjacent the first end and an end of the outer collar adjacent the first end is configured to exert an inward force on the plurality of deformable members such that the plurality of deformable members engage the inner shaft in the locked position.

The power tool of any one or more of the embodiments, wherein the outer collar includes a base portion and an inclined portion. The inclined portion is adjacent the first end, the inclined portion has a diameter that decreases from the base portion towards the first end, and the inclined portion is configured to engage the plurality of deformable members in the locked position.

The power tool of any one or more of the embodiments, wherein a force applied to the release button is configured to release the plurality of protrusions from the one or more slots and the biasing member is configured to rotate the outer collar in the second direction such that the outer collar moves towards the first end to the unlocked position when the force is applied to the release button.

The power tool of any one or more of the embodiments, wherein the biasing member is a torsional spring surrounding at least a portion of the inner collar.

A method of using a power tool includes providing a pole tool. The pole tool includes a housing including an electric motor, a work element, a shaft extending between the housing and the work clement, and a clamp extending along a longitudinal axis between a first end and a second end. The shaft includes an outer shaft and an inner shaft, and the inner shaft is configured to slide longitudinally within the outer shaft. The clamp is configured to secure the outer shaft and the inner shaft in a desired position. The clamp includes an inner collar and an outer collar configured to engage the inner collar. The method further includes rotating the outer collar of the clamp in a first direction about the inner collar such that the outer collar moves towards the first end to an unlocked position, translating the inner shaft within the outer shaft to the desired position, and rotating the outer collar of the clamp in a second direction about the inner collar such that the outer collar moves towards the second end to a locked position.

The method of any one or more of the embodiments, wherein the rotating the outer collar of the clamp in the first direction comprises rotating the outer collar less than or equal to 90° and the rotating the outer collar of the clamp in the second direction comprises rotating the outer collar less than or equal to 90°.

The method of any one or more of the embodiments, wherein the clamp further includes a biasing member surrounding at least a portion of the inner collar, the outer collar includes a plurality of protrusions extending from an interior surface of the outer collar, and the inner collar includes a release button. The release button defines one or more slots configured to engage the plurality of protrusions in the locked position. The rotating the outer collar of the clamp in the first direction includes applying a force to the release button such the plurality of protrusions disengage from the one or more slots and the biasing member rotates the outer collar in the first direction to the unlocked position.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A power tool comprising:
a housing including an electric motor;
a work element;
a shaft extending between the housing and the work element, wherein the shaft includes an outer shaft and an inner shaft; and
a clamp coupled to the shaft and extending along a longitudinal axis between a first end and a second end, wherein the clamp is actuatable between a locked position and an unlocked position, wherein the inner shaft is configured to slide longitudinally within the outer shaft when the clamp is in the unlocked position, and wherein the outer shaft and the inner shaft are secured in a desired position when the clamp is in the locked position, the clamp comprising:
an inner collar coupled to the outer shaft,
an outer collar rotatable about the inner collar between the locked position and the unlocked position, and
a collet within the outer collar adjacent the first end and configured to engage the inner collar in the locked position.

2. The power tool of claim 1, wherein:
an interior surface of the outer collar comprises a first plurality of threads adjacent the first end;
an exterior surface of the inner collar comprises a second plurality of threads adjacent the first end; and
the first plurality of threads are configured to engage the second plurality of threads.

3. The power tool of claim 1, wherein:
rotation of the outer collar in a first direction moves the outer collar and the collet towards the second end to the locked position;
rotation of the outer collar in a second direction moves the outer collar and the collet towards the first end to the unlocked position; and
the second direction is opposite the first direction.

4. The power tool of claim 3, wherein the collet is configured to engage the inner shaft in the locked position and prevent movement of the inner shaft.

5. The power tool of claim 3, wherein the collet is rotationally isolated from the outer collar.

6. The power tool of claim 3, wherein the outer collar is configured to rotate about the inner collar less than or equal to 90° in the first direction and less than or equal to 90° in the second direction.

7. The power tool of claim 1, wherein:
an end of the collet adjacent the second end defines a first inclined surface having a width increasing from the second end towards the first end;
an end of the inner collar adjacent the first end defines a second inclined surface having a width increasing from the first end towards the second end; and
the first inclined surface engages the second inclined surface in the locked position.

8. The power tool of claim 1, further comprising:
a mount configured to secure the inner collar to the outer shaft; and
one or more fasteners configured to secure the mount to the inner collar and the outer shaft.

9. The power tool of claim 8, wherein the mount comprises a cylindrical plate coupled to an interior surface of the outer shaft.

10. The power tool of claim 1, wherein the outer collar comprises a plurality of protrusions extending from an outer surface adjacent the first end, the plurality of protrusions spaced about a circumference of the outer collar.

11. A power tool, comprising:
a housing including an electric motor;
a work element;
a shaft extending between the housing and the work element, wherein the shaft includes an outer shaft and an inner shaft; and
a clamp coupled to the shaft and extending along a longitudinal axis between a first end and a second end, wherein the clamp is actuatable between a locked position and an unlocked position, wherein the inner shaft is configured to slide longitudinally within the outer shaft when the clamp is in the unlocked position, and wherein the outer shaft and the inner shaft are secured in a desired position when the clamp is in the locked position, the clamp comprising:
an inner collar coupled to the outer shaft,
an outer collar rotatable about the inner collar between the locked position and the unlocked position, the outer collar comprising a plurality of protrusions extending from an interior surface of the outer collar adjacent the second end,
a biasing member between the inner collar and the outer collar, and
a release button coupled to the inner collar, the release button defining one or more slots for receiving one or more of the plurality of protrusions of the outer collar.

12. The power tool of claim 11, wherein:
the inner collar includes a first plurality of threads extending from an outer surface of the inner collar adjacent the first end; and
the outer collar includes a second plurality of threads extending from an inner surface of the outer collar, the second plurality of threads configured to engage the first plurality of threads.

13. The power tool of claim 11, wherein:
rotation of the outer collar about the inner collar in a first direction moves the outer collar towards the second end to the locked position;
rotation of the outer collar about the inner collar in a second direction moves the outer collar towards the first end to the unlocked position; and
the second direction is opposite the first direction.

14. The power tool of claim 13, wherein:
the inner collar comprises a plurality of deformable members adjacent the first end; and
an end of the outer collar adjacent the first end is configured to exert an inward force on the plurality of deformable members such that the plurality of deformable members engage the inner shaft in the locked position.

15. The power tool of claim 14, wherein:
the outer collar comprises a base portion and an inclined portion, the inclined portion adjacent the first end, the inclined portion having a diameter that decreases from the base portion towards the first end; and
the inclined portion is configured to engage the plurality of deformable members in the locked position.

16. The power tool of claim 13, wherein:
a force applied to the release button is configured to release the plurality of protrusions from the one or more slots; and
the biasing member is configured to rotate the outer collar in the second direction such that the outer collar moves towards the first end to the unlocked position when the force is applied to the release button.

17. The power tool of claim 11, wherein the biasing member is a torsional spring surrounding at least a portion of the inner collar.

18. A method of using a power tool, comprising:
providing a pole tool, the pole tool comprising:
a housing including an electric motor,
a work element,
a shaft extending between the housing and the work element, wherein the shaft includes an outer shaft and an inner shaft, and wherein the inner shaft is configured to slide longitudinally within the outer shaft, and
a clamp extending along a longitudinal axis between a first end and a second end, the clamp configured to secure the outer shaft and the inner shaft in a desired position, the clamp including an inner collar and an outer collar configured to engage the inner collar;
rotating the outer collar of the clamp in a first direction about the inner collar such that the outer collar moves towards the first end to an unlocked position;
translating the inner shaft within the outer shaft to the desired position; and
rotating the outer collar of the clamp in a second direction about the inner collar such that the outer collar moves towards the second end to a locked position.

19. The method of claim 18, wherein:
the rotating the outer collar of the clamp in the first direction comprises rotating the outer collar less than or equal to 90°; and
the rotating the outer collar of the clamp in the second direction comprises rotating the outer collar less than or equal to 90°.

20. The method of claim 18, wherein:
the clamp further comprises a biasing member surrounding at least a portion of the inner collar;
the outer collar includes a plurality of protrusions extending from an interior surface of the outer collar;
the inner collar includes a release button, the release button defines one or more slots configured to engage the plurality of protrusions in the locked position; and
the rotating the outer collar of the clamp in the first direction comprises applying a force to the release button such the plurality of protrusions disengage from the one or more slots and the biasing member rotates the outer collar in the first direction to the unlocked position.
